(19) United States
(12) Patent Application Publication
(10) Pub. No.: US 2009/0078561 A1
(43) Pub. Date: Mar. 26, 2009

(54) Apparatus and Methods for Growing Nanofibres and Nanotips

(76) Inventors: Kenneth Boh Khin Teo, Cambridge (GB); Torquil Wells, York (GB); William Ireland Milne, Cambridge (GB); Mark Mann, Cambridge (GB); Mohamed Mochtar El Gomati, York (GB)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 12/179,699

(22) Filed: Jul. 25, 2008

Related U.S. Application Data
(60) Provisional application No. 60/962,398, filed on Jul. 30, 2007.

(51) Int. Cl. C01B 31/00; H05B 1/00; B01J 19/08

(52) U.S. Cl. 204/173; 219/201; 422/186.04; 204/164

(57) ABSTRACT

This invention relates to heating apparatus and methods with particular applications for growing a nanofibre, and to nanotips fabricated by such methods and apparatus. Embodiments of the invention can be implemented to provide nanotips for electron gun sources and scanning probe microscopy. A nanotip fabrication apparatus includes a heater for heating an object in the presence of an electric field. The heater comprises: a substantially planar electrically conductive heating element configured to define at least one aperture; a support to mount the heated object such that it protrudes through said aperture; and at least one electrical connection to said heating element. In use, the heating element can be biased by said at least one electrical connection such that the electric field in the vicinity of the object is substantially perpendicular to the plane of the element.

### RELATED APPLICATIONS

The present invention claims priority from U.S. Provisional Patent Application No. 60/962,398, filed Jul. 30, 2008.

### FIELD OF THE INVENTION

This invention relates to heating apparatus and methods with particular applications for growing nanofibre-type materials such as nanotubes and nanowires on a metallic tip. The invention also relates to apparatus and methods for growing nanofibres on metallic tips, and to nanotips fabricated by such methods and apparatus. Embodiments of the invention are particularly useful for providing nanotips for electron gun sources and scanning probe microscopy.

### BACKGROUND OF THE INVENTION

When wishing to heat a sharp, metallic tip/wire in an electric field, the possibility of an arc discharge to that wire is risked (because of the concentration of electric field at the pointed tip which causes electrical breakdown). This is of particular concern to scientists and engineers attempting to deposit or react chemical species on the surface of a tip/wire in the presence of an electric field or plasma, as arc discharging/electrical breakdown can undesirably affect the chemistry of many chemical and physical process, in particular the growth of nanofibre-type materials such as nanotubes or nanowires. If this occurs, the tip of the metallic wire is also usually destroyed/melted.

Existing methods of heating a metallic tip/wire involve either clamping or welding the metallic tip onto a second wire, with current passing through the second wire. The second wire resistively heats up, and heat is transported to the end of the first wire by conduction. However, this has the following limitations when used for growth of nanofibre-type materials:
1. The temperature of the tip of the wire is unknown—unless expensive thermometry techniques are used.
2. The temperature is not well controlled and can change in the presence of gases due to the heat loss from the tip.
3. This cannot be operated with high voltage or high field in the presence of gases as it would cause arc discharge/electrical breakdown due to the field enhancement of the first wire.

We will describe techniques which shield the tip/wire from the field enhancement at the sharp point, which causes the discharge/electrical breakdown to take place. The techniques we describe advantageously facilitate simultaneously heating of the tip/wire and also the maintenance of an electric field of a defined direction at or near the apex of the tip/wire; this field may also be maintained such that it is substantially constant. The techniques are particularly useful for the growth of an aligned nanofibre on an object.

Background prior art can be found in Chemical Physics Letters 272 (1997), 178-182, “Well-aligned graphitic nanofibres synthesized by plasma-assisted chemical vapor deposition”, Yan Chen, Zhong Lin Wang, Jin Song Yin, David J. Johnson, and R. H. Prince; International Patent No. WO99/65821; US Patent No. US2002/024279 and International Patent No. WO 02/19372; US Patent No. US2002/0117951; European Patent No. EP 1129990; European Patent No. EP 1046613; and Japanese Patent No. JP2002/069756. Reference may be made to these documents for detailed examples of the growth of carbon nanofibres by means of plasma assisted CVD. Further background prior art can be found in US 2003/148577 & US 2002/046953.

### SUMMARY OF THE INVENTION

According to a first aspect of the invention there is therefore provided a heater for heating an object in the presence of an electric field, the heater comprising: a substantially planar electrically conductive heating element configured to define at least one aperture; a support to mount the heated object such that it within the aperture; and at least one electrical connection to said heating element; whereby, in use, the heating element is biassable by said at least one electrical connection such that the electric field in the vicinity of the object is substantially perpendicular to the plane of the element.

Preferably the heating element is substantially flat, or at least locally flat in the vicinity of the aperture, and preferably the heated object is supported so that it is level with or slightly protrudes through the aperture. In embodiments the heating element may comprise an electrically conductive plate or strip mounted on a ceramic support, preferably spaced away from the support to facilitate gas flow around the heated object in nanotip fabrication apparatus. The heating element may be heated directly, for example by providing a pair of electrical connections to enable the electrically conductive plate to be ohmically heated by passing a current through it. In this case the electrical conductor may comprise a somewhat resistive material such as graphite. Alternatively the electrically conductive heating element may be heated in some other way—for example it may be heated by a radiant heater such as a quartz tube heater.

Embodiments of the above described heater construction allow chemical reactions to take place in the presence of a high voltage and/or plasma without substantial electric arc discharge or electrical breakdown. This is because the flat, planar conductive plate or strip shields the object, typically a pointed substrate such as a metallic tip or wire, from creating large electric fields which would otherwise arise from the geometry of the object in a high field or high voltage environment. Furthermore the flat, planar electrically conductive heating element constrains the electric field to be substantially perpendicular to the plane of the element. In nanotip fabrication apparatus this results in vertically aligned growth of one or more nanofibres (such as nanotubes or nanowires) on the object, which is highly desirable for a range of applications.

In some preferred embodiments the aperture has a dimension, for example a diameter in the case of a circular aperture, of less than 1 mm, preferably less than 0.5 mm. As previously mentioned, typically the heated object comprises a wire, which may have a sharpened end/tip, or some similarly shaped pointed object, in which case a relatively small aperture assists in keeping the wire (or other object) substantially vertical. A small aperture also helps to ensure that the electrically conductive heating element and the wire/tip are at a similar or substantially the same temperature. This helps to overcome another problem with prior art techniques, where the wire temperature is generally not well controlled. By contrast in embodiments of the present apparatus the temperature of the electrically conductive element can be controlled very precisely, for example with an accuracy of order 1° C. by resistive heating, even under the flow of reactive gases. Preferably, therefore, the heater includes a thermocouple or other temperature sensing device in thermal contact with the electrically conductive heating element, for measuring (indirectly) a temperature of the object. A feedback loop for temperature control may then also be implemented.

Preferably the support is adjustable to control the protrusion of the object through the aperture, and may comprise a screw. This facilitates adjustment so that a sharp end or tip of the object is level with or just slightly protrudes from the surface. Preferably the heater is arranged to electrically connect the object to the heating element, for example by direct contact between the two or indirectly via the support. This facilitates provision of a uniform, perpendicular electric field in the vicinity of the (electrically conducting) object. A power supply may be included to bias the heating element/object to control the electric field in the vicinity of the object. This may comprise, for example a dc power supply with an output voltage in the range 0.1 KV to 10 KV. A complementary electrode may be provided to apply this voltage; optionally this complementary electrode may be perforated to allow the passage of gas into/through a reaction chamber in which the heater is to reside.

One particularly useful feature of the heater, especially when intended or adapted for use with nanotip fabrication apparatus, is the scalability of the design to allow multiple nanotips to be fabricated simultaneously. Thus in some preferred embodiments the electrically conductive heating element is provided with a plurality of apertures for simultaneous heating of a plurality of objects, such as a plurality of wires, within a single, common reaction chamber. This facilitates mass production of nanotips.

The invention also provides nanotip fabrication apparatus including a heater as described above.

Thus in a further aspect the invention provides nanotip fabrication apparatus for fabricating a nanofibre on a tip of an object, the apparatus comprising: a reaction chamber including a first electrode; a gas supply connection for supplying gas to the reaction chamber; a heater, the heater having an electrically conducting surface in which is provided an aperture within which the tip is able to be supported; and first and second electrode connections, said first electrode connection being connected to said first electrode, said second electrode connection being connected to said electrically conducting surface.

The object on which a nanotip is fabricated is typically a pointed, electrically conducting (generally metal) object such as a tungsten wire. Preferably the apparatus is configured so that the tip can be supported within the aperture so that it is level with or protrudes slightly from the aperture. The nanotip preferably comprises a nanofibre, more particularly a carbon-based nanofibre such as a single- or multi-walled nanotube. Broadly speaking what is meant by a nanotip is an object with a nanoscale end, nanoscale meaning less than 1000 nm across, more preferably less than 100 nm, typically in the range 1-10 nm. The aperture through which the object tip is to protrude has a lateral dimension of, in order of increasing preference, less than 5 mm, 1 mm, 0.5 mm, 0.2 mm.

The first and second electrode connections may connect to the first electrode and electrically conducting surface respectively either with or without intermediary components. Preferably the apparatus includes a power supply connection for connecting a power supply to the heater although, for example, an external, radiant heater may be employed.

Preferably the electrically conducting surface is configured in such a way that when, in use, a voltage is applied between the first and second electrode connections an electric field is generated which, in the vicinity of the tip is substantially in a direction in which the tip points, that is for a wire, substantially parallel to the wire. Thus preferably the electrically conducting surface is substantially planar at least in the vicinity of the aperture, in which case the electric field is substantially perpendicular to the plane of the conducting surface. In particularly preferred embodiments the electrically conducting surface has a plurality of apertures for fabricating a plurality of nanotips simultaneously, for example by inserting a wire through each aperture so that each wire end is level with or just protrudes from the conducting surface. A single, common support or a plurality of separate supports, for example separate screws, may be provided for the plurality of apertures.

In a related aspect the invention provides a method of heating an object in an electric field, the method comprising: shielding the object from part of the electric field by mounting the object in an aperture in an electrical conductor, said conductor being substantially planar in the vicinity of said aperture; biasing said electrical conductor such that the electrical field in the vicinity of the object is primarily perpendicular to said plane; and heating the object.

Correspondingly the invention further provides a heater for heating an object in an electrical field, the heater comprising: a shield for shielding the object from part of the electric field, the shield comprising an electrical conductor defining at least one aperture; said conductor being substantially planar in the vicinity of said aperture; and an electrical connection for biasing said electrical conductor such that the electrical field in the vicinity of the object is primarily perpendicular to said plane; and a heater for heating the object.

The invention further provides a method of growing a nanofibre on the tip of a metallic object by heating at least the tip of the object in an electric field in the presence of a gaseous supply of material for fabricating the nanofibre, the method including controlling said electric field to be substantially in the direction of said tip during the growing by mounting said tip within an aperture in an electrical conductor.

Preferably the tip is mounted such that it is substantially level with or protrudes through the aperture.

Typically the gaseous supply of material comprises a plasma. Methods for generating such a plasma and are well known to those skilled in the art.

Embodiments of the described methods are particularly useful for fabricating electron gun sources (and hence electron guns) and scanning probe microscopy tips such as AFM (Atomic Force Microscopy) tips and STM (Scanning Tunnelling Microscopy) tips.

The invention further provides an object with a pointed metallic tip and having a nanofibre attached substantially at the end point of said tip.

In some preferred examples the object comprises a wire such as a tungsten wire, but the skilled person will appreciate that nanofibres may be attached to other pointed metal objects, depending upon the desired application. Preferably the nanofibre is attached substantially at the centre of the tip, and preferably it is aligned substantially parallel to a direction which the tip (or wire) points. Preferably only a single nanofibre is attached at the end point of the tip. Objects of this type may be obtained, for example, by repeatedly fabricating nanotips as described above and then selecting those on which only a single fibre has been grown.

In preferred embodiments the nanofibre comprises a nanowire or nanotube of material such as carbon, zinc oxide, silicon or other single elements or compounds. Here, as before, the nanofibre preferably has a lateral dimension or average diameter of less than 1000 nm, more preferably less than 100 nm or less than 50 nm. As previously mentioned, such an object can advantageously be employed as an electron gun source or scanning probe microscopy tip.

### BRIEF DESCRIPTION OF THE DRAWINGS

These and other aspects of the invention will now be further described, by way of example only, with reference to the accompanying figures in which:

FIG. 1 shows nanotip fabrication apparatus embodying an aspect of the present invention;

FIG. 2 shows a heater according to an embodiment of an aspect of the present invention;

FIGS. 3a and 3b show electric field lines for a sharp, metallic tip in an electric field, (a) unshielded, and (b) shielded by the heater of FIG. 2;

FIGS. 4a and 4b show, schematically, an object tip with a nanotube attached according to, respectively, a conventional method, and a method according to an embodiment of an aspect of the present invention;

FIGS. 5a and 5b show electron microscopy photographs of actual objects corresponding to the schematic diagrams of FIGS. 4a and 4b; and

FIGS. 6a and 6b show examples of an electron source and a scanning probe microscope tip incorporating the nanotip of FIGS. 4b and 5b; and

FIGS. 7a to 7c show, respectively, a vertical cross-section and perspective view of an electric field suppressor module for the apparatus of FIG. 1, and a cross-section through a heater stage incorporating a plurality of the modules.

### DETAILED DESCRIPTION OF PREFERRED EMBODIMENTS

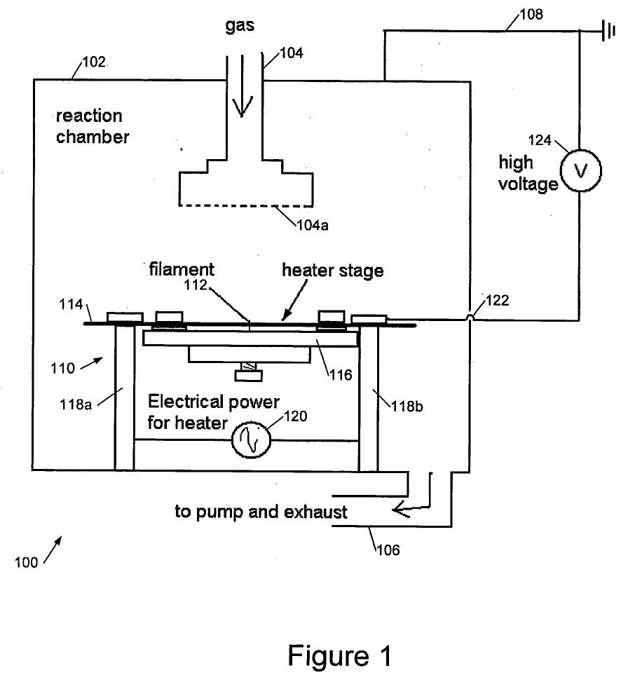

Referring first to FIG. 1, this shows nanotip fabrication apparatus 100 comprising a reaction chamber 102 in which plasma-enhanced chemical vapour deposition (PE-CVD) or chemical vapour deposition (CVD) in the presence of an electric field of nanofibres may be performed. Gas for growing the nanofibres enters a reaction chamber inlet 104 and exhausts to a pump through an outlet 106. In a preferred embodiment a first electrode for striking a plasma or generating the electric field in the growth environment is formed by inlet 104, which is made of metal. In the illustrated example reaction chamber 102 is also made of metal and provided with an earth connection 108; in other embodiments reaction chamber 102 may be fabricated from an electrically insulating material such as glass. In the illustrated embodiment gas inlet/electrode 104 has the form of a “showerhead”, with a grill 104a to disperse the gas within the reaction chamber.

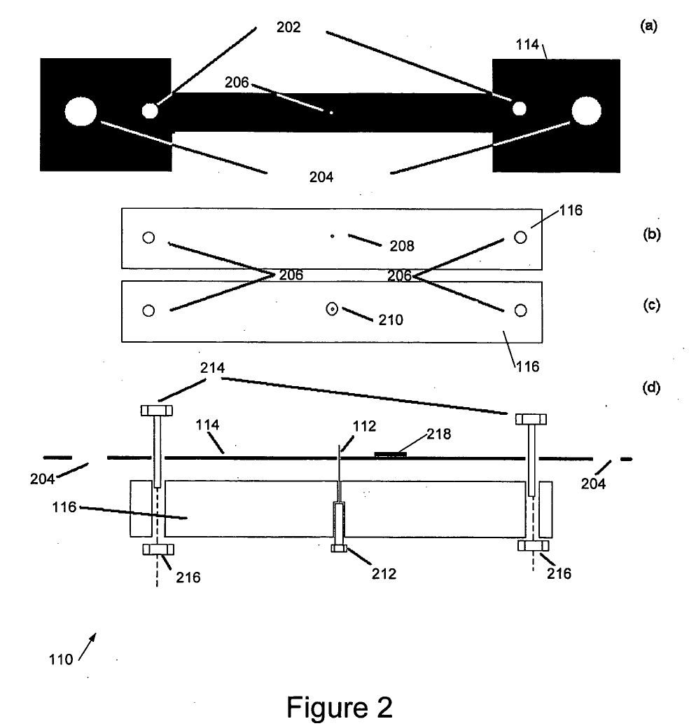

Also incorporated within the reaction chamber 102 is a heater stage 110 supporting a filament 112 such as a wire or tip, at the end of which a nanofibre is to be grown. The heater stage 110 comprises a flat, planar electrical conductor 114 mounted on a support 116, preferably formed from ceramic because of the high electric fields, and spaced away from conductor 114 to facilitate circulation of the growth gas. Filament 112 projects through a small aperture in conductor 114, as is explained in more detail with reference to FIG. 2. In some particularly preferred embodiments conductor 114 is provided with an array of apertures so that nanofibres may be grown simultaneously on a plurality of filaments.

In one embodiment electrical connections are made to either end of conductor 114 for example by means of conducting supports a, b, electrically insulated from the reaction chamber 112 if the reaction chamber is made of metal. The electrically conducting supports 118a, b may be taken out to external connections on the reaction chamber for connection to an electrical power supply 120 for the heater; alternatively this power supply may be located within the reaction chamber. In other embodiments the electrical conductor 114 of the heater stage may be heated indirectly, for example radiatively It will be appreciated, however, that at least conductor 114 must conduct both heat and electricity. At least one external connection 122 is provided to conductor 114 to allow this to be connected to an external high voltage power supply 124.

FIGS. 2a to 2d show the sharp wire heater 110 of FIG. 1 in more detail. FIG. 2a shows a top view of the heater, and in particular of a preferred graphite heating element 114 (without screws); FIG. 2b shows a top view of the ceramic support (without screws); FIG. 2c shows a bottom view of the ceramic support (without screws); and FIG. 2d shows a vertical cross-section through the heater assembly, with screws included. Preferably all screw holes shown in FIG. 2 are threaded.

In FIG. 2a the flat, planar graphite heater 114 has a first pair of screw holes 202 for holding screws for the heater, a second pair of holes 204 for electrical contacts to the heater, and (in this example) a single hole 206 for wire or filament 112. The ceramic support 116 insulates both heat and electrical current. Referring to FIGS. 2b and 2c, holes 206 are provided for the holding screws and a hole 208 for the wire/filament 112. The lower part of the support 116 is provided with a larger, threaded hole 210 concentric with hole 208 to receive a screw 212 to support and raise/lower the height of the filament/wire/tip 112. Optionally a cylindrical spacer closely fitting aperture 208 may be provided above screw 212 to reduce the risk of filament 112 become stuck down the side of the screw.

FIG. 2d shows the previously mentioned features in cross-section, the assembly being held together by holding screws 214 and holding nuts 216. A temperature sensor 218 such as a thermocouple may be located on or embedded in conductor 114, preferably adjacent filament 112 if space permits.

In preferred embodiments an electrical connection is made between wire/filament 112 and heater conductor 114. This may arise because the wire is a close fit in hole 206 or, in embodiments, a direct electrical connection may be made, for example from screw 212 to one of holding screws/nuts 214, 216.

In use a typical procedure involves placing the wire 112 in its hole 206, 208 with the supporting screw 212 tightened fully. The screw is then unwound to lower the level of the wire so that the top is level with that of the heater 114. Current is passed through the strip heater 114, which in turn heats the wire, as it is leans against the graphite heater. In embodiments the temperature of the heater strip or plate 114 closely matches that of the tip of the wire/filament, which ameliorates problems with prior art techniques, where the gas tends to cool the tip. The temperature is measured using the thermocouple 218, and the temperature can be adjusted by altering the level of current passing through the heater using power supply 120.

An electric field or plasma is created perpendicular to the heater (and hence the tip) by biasing the heater with respect to earth. In high electric fields (typically greater than 10³V/m, generally greater than 10⁴V/m) a nanofibre grows substantially straight and vertical, whereas in prior art techniques nanofibre spaghetti is a common result.

After the process is completed, the supporting screw is tightened to raise the height of the wire, which can then be picked up by tweezers.

The method used to fabricate a nanofibre can be tailored to meet the needs of the nanofibre required. Broadly speaking any conventional PE-CVD or CVD (in the presence of an electric field) nanofibre fabrication technique may be used with the apparatus, to seek the benefits described above.

The control parameters of the method and how they affect the process are listed below:
Growth time: The height of nanotubes grown is a function of growth time. Our process typically grows nanotubes at a rate of 8 microns per hour.
Catalyst thickness: We use two thin films to form the catalyst ‘seed’ from which the nanotube grows. The first film (the bottom film) is always the same thickness. It is a conductive buffer layer of either Indium Tin Oxide, Titanium Nitride or Tantalum Nitride, thickness ˜15 nm though this is not critical. This prevents the top layer from diffusing into the wire/filament (often a metal) which would result in there being no catalyst to start nanotube growth. The top layer is the catalyst, commonly nickel or iron or cobalt. The diameter of the carbon nanotube is directly affected by the thickness of the catalyst film. Catalyst thickness is typically 2-7 nm.
Temperature: The higher the growth temperature, the fewer imperfections in the carbon nanotube and the faster it grows. Growth typically starts around 500° C.
Pressure of gas: The higher the pressure, the higher the growth rate.
Flow rate of gas: The higher the flow rate, the higher the pressure for a fixed pumping speed.

### A Description of a Typical Experimental Run

The filaments (tungsten wires etched to form a sharp tip) were coated firstly with a thin layer to act as a diffusion barrier (exampled by Indium Tin Oxide, Titanium Nitride or Tantalum Nitride). Secondly, a thin coating of catalyst metal was applied (e.g. nickel, iron, cobalt). The tips were then loaded into the heater and the reactor was pumped down to a base pressure of 10⁻² mBar. The reactor was then filled with an reducing/dilution gas (e.g. ammonia) at a flow of 120 sccm, corresponding to a partial pressure of 2.5 mbar. The tip was then heated to 700° C. Upon reaching the deposition temperature, the heater was biased at −600V to initiate a d.c. glow discharge. The growth gas, normally but not exclusively acetylene, was then inlet for the growth of the nanotip (e.g. carbon nanotube), at a rate of 30 sccm (cubic centimetres per minute) and with the total reactor partial pressure at 3.2 mbar. The length of the carbon nanotube depends on the deposition time. Upon completion, the gases, plasma and heater are turned off and the tip is allowed to cool to room temperature.

The skilled person will recognise that nanofibres (ie. nanotubes or nanowires) of other materials, for example Zinc Oxide, may be grown with the above described apparatus. The fabrication method can be adapted according to the materials grown by selecting the gaseous feedstock and metal catalyst.

The skilled person will understand that by fabricating a heater with a plurality of apertures in heater 114 a plurality of nanofibre tips may be fabricated in parallel (ie. simultaneously). A separate supporting screw 212 may be provided for each object, object part or filament on which a tip is to be formed, or a single, common support may be employed.

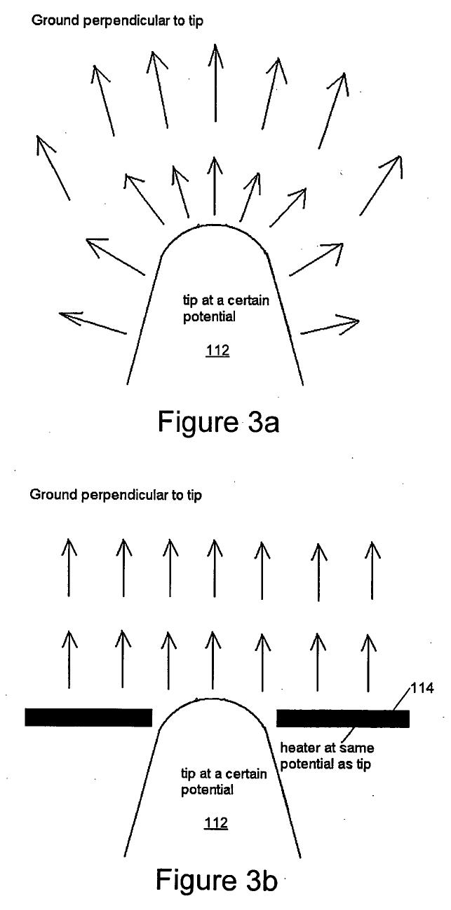

FIGS. 3a and 3b illustrate electric field lines at the tip of filament 112 in the absence, and presence respectively of heater conductor 114. It can be seen that when shielded by conductor 114, with the tip 112 and heater 114 at substantially the same potential the electric field lines are substantially perpendicular to conductor 114 (when the ground electrode is in the direction in which the tip is pointing). The electric field lines are parallel to tip 112 at its apex.

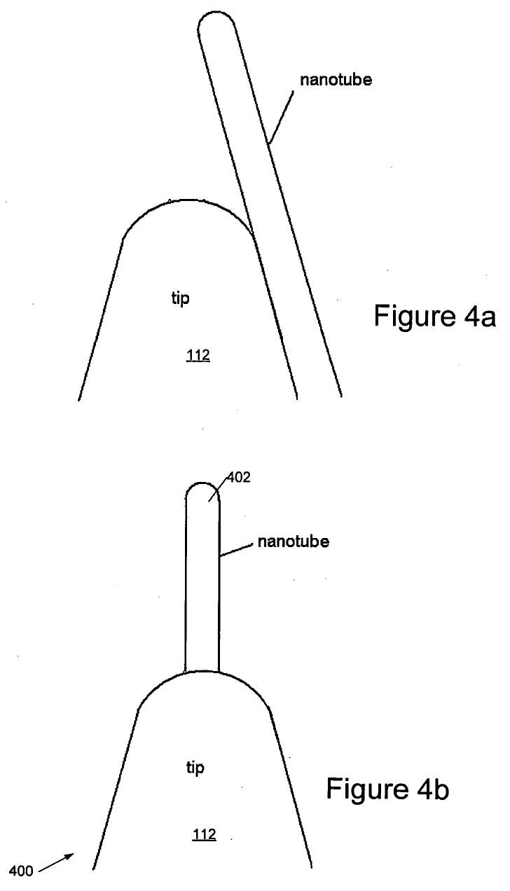

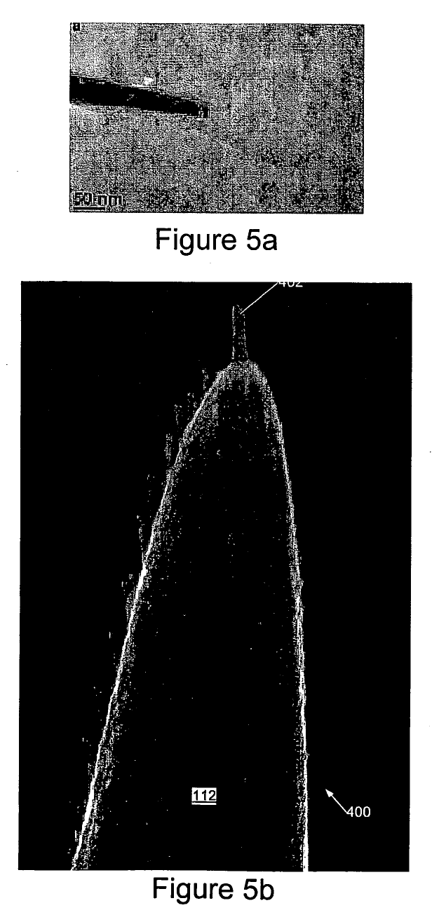

The results of growing a nanofibre on tip 112 with the electric field distribution of FIG. 3b are shown in FIGS. 4b and 5b respectively. These show a nanotip 400 comprising a wire tip 112 at the end of which, substantially at the apex of the tip and pointing in the same direction of the tip, has been grown a single carbon nanotube 402. The results can be contrasted with the best results of prior art techniques, as shown in FIGS. 4a and 5a, in which a nanotube is attached to the end of a tip using manipulation (FIG. 5(a) is taken from Niels de Jonge, Yann Lamy, Koen Schoots, Tjerk H. Oosterkamp, Nature 420, 393-395 (2002)). It can be seen that the nanotube is not attached to the end of the tip, nor at the centre of the tip, and nor does it point in a direction parallel to direction in which the tip points.

Referring to FIG. 5b it can be seen that, at least in some instances, carbon nanotubes (CNTs) grow substantially vertically upward. The vertical growth of the nanotubes at the apex of the wire/filament may be due to one or more of the following list of effects: 1) the electric field at the tip; 2) growth along the general direction of ions at the tip (ie vertical-ions are heavy and gain energy so that they may not much be affected by local field perturbations); 3) vertical ion bombardment/etching at the tip, although other effects may additionally or alternatively play a part. The additional nanotubes attached to the side of filament 112 do not much affect applications such as an electron gun or scanning probe microscopy tip (in the case of an electron gun the file is much higher at the end of the nanofibre on the tip than at the ends of the nanofibres on the side of the filament).

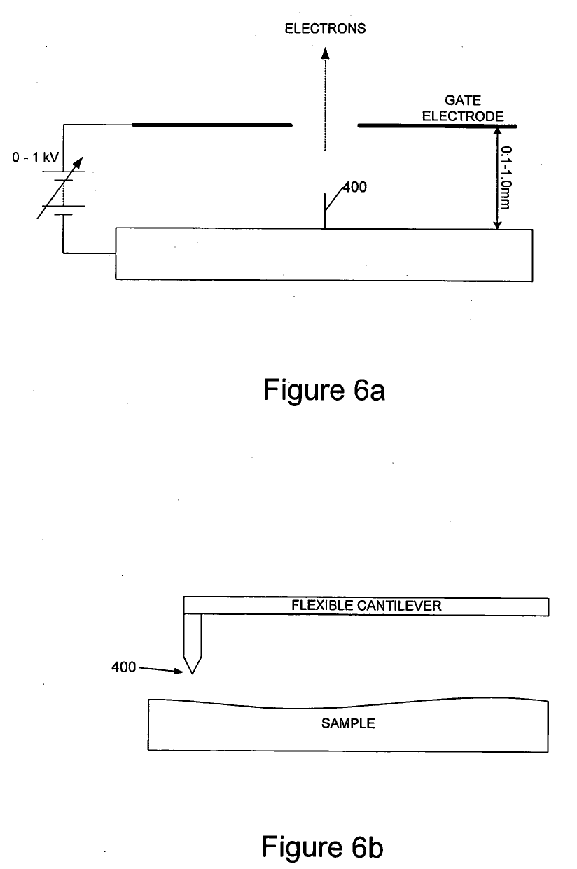

FIGS. 6a and 6b show how the nanotips of the FIGS. 4b and 5b may be incorporated into an electron source and into a scanning probe microscopy tip respectively.

As described above an etched tungsten tip is placed inside the ceramic stage, lowered to the height of the stage and heated.

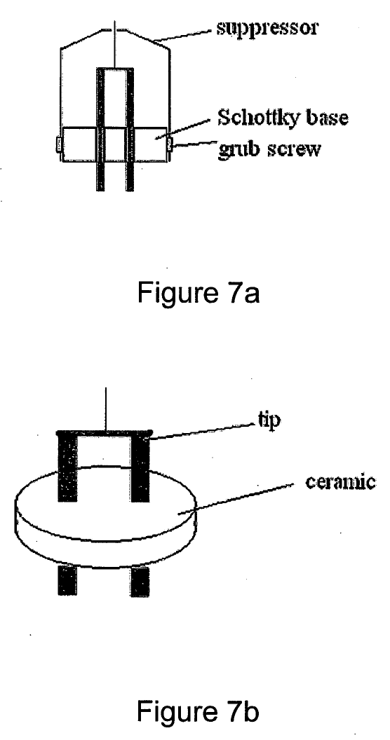

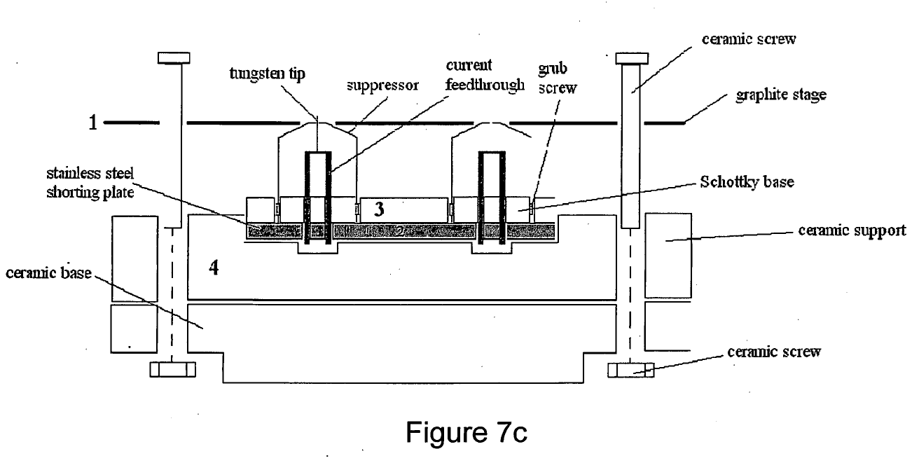

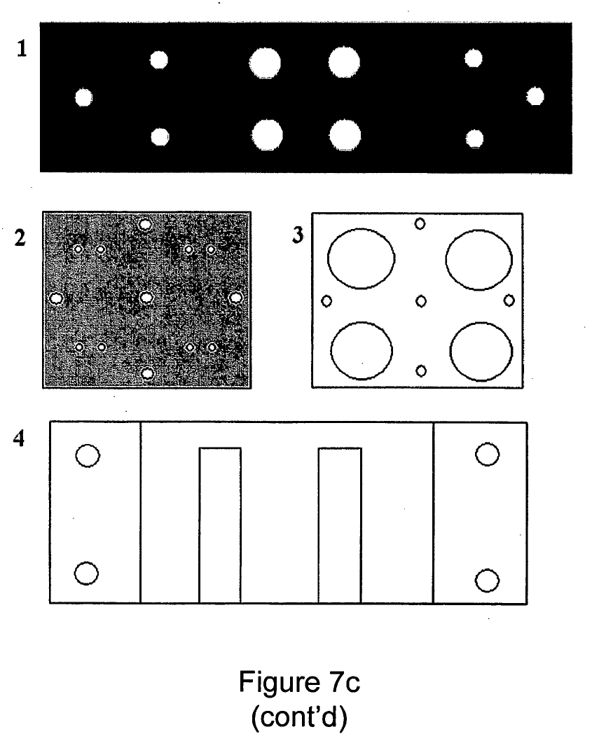

In the inventor's current best embodiment an entire electron source module, comprising a suppressor and a prealigned etched tungsten tip mounted on a (Schottky) base is placed inside the stage. Other types of electron sources than a Schottky electron source may be employed. FIG. 7a shows the cross section of the suppressor module (electric field shield) and FIG. 7b a perspective view of the module.

FIG. 7a shows a cross section of the suppressor (metallic cover) and Schottky base (with attached tip) assembly. The etched tungsten wire is seen to just protrude through a small hole in the suppressor (which is the same principle as above). The difference this time is that this is preferably in a module that can fit into an electron microscope, be plugged in and work because it is already aligned axially. The height of the tip within the suppressor can be controlled by grub screws. This is carefully controlled since it determines the distance by which the tip protrudes into the plasma.

FIG. 7c shows how four suppressor modules can be placed inside the stage. In FIG. 7c plate 2 is attached to base 3 with small ceramic screws, and 2+3 are free to slide back and forth when placed on 4. Block 4 has a trench cut into it so that the current feedthroughs can pass easily when 2+3 is slid. The ceramic screws raise and lower the height of the whole ceramic holding stage so that the suppressors can be brought into contact with the graphite stage. Plate 2 shorts the suppressor to the current feedthrough and hence the tip, so all are at the same potential. This stage uses essentially the same principle as above with a ceramic stage. Given there is no electrical contact between the suppressor and the tip, a steel plate is inserted at the bottom of the suppressor-tip assembly to short one to the other. This is required so that the field at the level of the graphite stage remains planar. The ceramic screws raise and lower the height of the entire modules now, not just the etched wires. When the suppressors come into physical contact with the graphite stage, they also make electrical contact. Now stage, suppressor and tip are all at the same potential, thus creating a largely planar surface with the tips protruding slightly into an applied plasma.

FIG. 7c shows a currently preferred heater stage. The steel support can be ceramic also, with only a small plate below the ceramic holder required to be metallic.

The main advantage of this setup is the fact that the alignment of the etched wires within the stage is more accurate, albeit the sources it creates tend to be more unstable. The skilled person may be able to improve upon the illustrated arrangement by routine experimentation.

The skilled person will recognise that many variants on the above described apparatus and methods are possible. Embodiments of the heating apparatus can be used to grow nanotubes and nanowires of a variety of materials, including carbon, by placing a substrate on the heater. The aperture 206 in the conductor 114 can be modified according to the application in order to adapt the heater for heating a great variety of objects which are small but which it is desired to heat to a precise temperature, particularly in the presence of a plasma/electric field. Applications of nanotips fabricated by the above described methods/apparatus include electron gun sources, AFM (Atomic Force Microscopy) tips, STM (Scanning Tunnelling Microscopy) tips, and a range of other structures requiring nanoscale features. For example nanotips fabricated in accordance with the above method/using the above apparatus may be employed to fabricate a field-emission display pixel.

No doubt many other effective alternatives will occur to the skilled person. It will be understood that the invention is not limited to the described embodiments and encompasses modifications apparent to those skilled in the art lying within the spirit and scope of the claims appended hereto.

1. A nanotip fabrication apparatus including a heater for heating an object in the presence of an electric field, the heater comprising:
a substantially planar electrically conductive heating element configured to define at least one aperture;
a support to mount the heated object within said aperture; and
at least one electrical connection to said heating element;
whereby, in use, the heating element is biassable by said at least one electrical connection such that the electric field in the vicinity of the object is substantially perpendicular to the plane of the element.

2. A nanotip fabrication apparatus as claimed in claim 1 wherein said heating element is substantially flat and comprises an electrically conductive plate mounted on a ceramic support.

3. A nanotip fabrication apparatus as claimed in claim 2 wherein said object comprises a metallic wire or tip, and wherein said substantially planar electrically conductive heating element is configured to shield said object from creating large electric fields, and further comprising a power supply to bias said heating element to control the electric field in the vicinity of the object.

4. A nanotip fabrication apparatus as claimed in claim 1 further comprising a suppressor module for containing said wire and wherein said aperture is an aperture in said suppressor module.

5. Nanotip fabrication apparatus for fabricating a nanofibre on a tip of an object, the apparatus comprising:
a reaction chamber including a first electrode;
a gas supply connection for supplying gas to the reaction chamber;
a heater, as claimed in claim 1; and
first and second electrode connections, said first electrode connection being connected to said first electrode, said second electrode connection being connected to said electrically conducting surface.

6. Nanotip fabrication apparatus as claimed in claim 5 wherein said electrically conducting surface is configured such that when, in use, a voltage is applied between said first and second electrode connections an electric field is generated which, in the vicinity of said tip, is substantially in a direction in which the tip points.

7. A heater for heating an object in an electrical field, the heater comprising:
a shield for shielding the object from part of the electric field, the shield comprising an electrical conductor defining at least one aperture; said conductor being substantially planar in the vicinity of said aperture; and
an electrical connection for biasing said electrical conductor such that the electrical field in the vicinity of the object is primarily perpendicular to said plane; and
a heater for heating the object.

8. A method of nanotip fabrication including heating an object in an electric field, the method comprising:
shielding the object from part of the electric field by mounting the object in an aperture in an electrical conductor, said conductor being substantially planar in the vicinity of said aperture;
biasing said electrical conductor such that the electrical field in the vicinity of the object is primarily perpendicular to said plane; and
heating the object.

9. A method as claimed in claim 8 wherein said heating comprises passing a current through said conductor to electrically heat said conductor to thereby heat said object.

10. A method as claimed in claim 8 wherein said object comprises a sharp metallic object for an electron gun or electron gun source or for a tip for a scanning probe microscope.

11. A method of growing a nanofibre on the tip of a metallic object by heating at least the tip of the object in an electric field as claimed in claim 8 in the presence of a gaseous supply of material for fabricating the nanofibre, the method including controlling said electric field to be substantially in the direction of said tip during the growing by mounting said tip within an aperture in an electrical conductor.

12. A method as claimed in claim 11 wherein said object comprises a wire and wherein said heating comprises heating using said electrical conductor.

13. A method of growing a plurality of nanofibres on a respective plurality of object tips in a common reaction chamber, the method comprising growing each nanofibre using the method of claim 11 by mounting each tip such that it protrudes through a respective said aperture in an electrical conductor within said common reaction chamber.

14. An object having a nanotip or nanofibre fabricated by the method of claim 8.

15. An object as claimed in claim 14 with a pointed metallic tip and having a nanofibre attached substantially at the end point of said tip.

16. An object as claimed in claim 15 wherein said nanofibre is attached substantially at the centre of said tip, or wherein said nanofibre is substantially parallel to a direction in which said tip points, or wherein a single nanofibre is attached at said end point of said tip.

17. An object as claimed in claim 14 wherein said nanofibre comprises a carbon nanofibre; and wherein said object comprises a wire.

18. An object as claimed in claim 14 wherein the object is a scanning probe microscope tip.

19. An object as claimed in claim 14 wherein the object is an electron gun or electron gun source.
